(19) United States
(12) Patent Application Publication
(10) Pub. No.: US 2026/0365416 A1
(43) Pub. Date: Nov. 19, 2026

(54) TAILGATE ASSEMBLY FOR A ROLL-OFF CONTAINER

(71) Applicant: Ryan Peterkin, Nikiski, AK (US)

(72) Inventor: Ryan Peterkin, Nikiski, AK (US)

(21) Appl. No.: 19/753,935

(22) Filed: Jul. 24, 2026

Related U.S. Application Data
(63) Continuation-in-part of application No. 18/483,491, filed on Oct. 9, 2023, now Pat. No. 12,715,684.
Application No. 18/483,491 is a continuation of application No. 17/838,508, filed on Jun. 13, 2022, now Pat. No. 11,884,482.
Application No. 17/838,508 is a continuation of application No. 17/833,137, filed on Jun. 6, 2022, now Pat. No. 11,772,884.
Application No. 17/833,137 is a continuation-in-part of application No. 17/579,792, filed on Jan. 20, 2022, now Pat. No. 11,396,419.
Application No. 17/579,792 is a continuation-in-part of application No. 17/531,989, filed on Nov. 22, 2021, now abandoned.
Application No. 17/531,989 is a continuation-in-part of application No. 17/396,403, filed on Aug. 6, 2021, now Pat. No. 12,077,362.

(51) Int. Cl. B65D 88/12; B60P 3/22; B65D 81/20; B65D 88/02; B65D 88/74; B65D 90/00; B65D 90/10

(52) U.S. Cl. CPC B65D 88/128; B60P 3/2205; B60P 3/226; B60P 3/2295; B65D 81/20; B65D 88/022; B65D 88/744; B65D 88/748; B65D 90/0033; B65D 90/008; B65D 81/2015; B65D 90/10; B65D 2588/74

(57) ABSTRACT

A tailgate assembly for a roll-off container includes a tailgate; a hinge assembly mounted the tailgate, such that the tailgate is movable between an open position and a closed position about a hinge axis parallel to a top of the tailgate; a hydraulic actuation system operable to move the tailgate between the open position and the closed position; and a hydraulic lock assembly to maintain the tailgate in the closed position.

### CROSS-REFERENCE TO RELATED APPLICATION(S)

This application claims the priority as a continuation-in-part of U.S. Nonprovisional patent application Ser. No. 18/483,491(01942-PET) filed Oct. 9, 2023 material which claims the priority as a continuation of U.S. Nonprovisional patent application Ser. No. 17/838,508(01690-PET) filed Jun. 13, 2022 which is a continuation-in-part of U.S. Nonprovisional patent application Ser. No. 17/833,137(01689-PET) filed Jun. 6, 2022 which is a continuation-in-part of U.S. Nonprovisional patent application Ser. No. 17/579,792(01493P02-PET) filed Jan. 20, 2022 which issued as U.S. Pat. No. 11,396,419 on Jul. 26, 2022 and is a continuation-in-part of U.S. Nonprovisional patent application Ser. No. 17/531,989(01450-PET) filed Nov. 22, 2021 which is a continuation-in-part of U.S. Nonprovisional patent application Ser. No. 17/396,403 (01393-PET) filed Aug. 6, 2021 which issued as U.S. Pat. No. 12,077,362.

Each of the aforementioned patent applications, and any applications related thereto, are herein incorporated by reference in their entirety.

### FIELD OF TECHNOLOGY

This disclosure relates generally to technology for roll-off self-contained cutting boxes for heated slurry transport, receiving, and dumping in cold climates with freezing temperatures.

### BACKGROUND

Drill cuttings are produced during drilling of oil wells and gas wells. The drill cuttings are carried to the surface by a drilling fluid circulating up from the drill bit. The drill cuttings are separated from the drilling fluid so the recycled drilling fluid may be reused during the drilling process. The separated drill cuttings along with a portion of the drilling fluid and other fluids form a cuttings slurry that may be often transported to a vacuum tank for holding until full. Once the tank may be full of the cuttings slurry, the slurry cuttings may be transported to a disposal facility.

One problem with conventionally transporting slurry cuttings in a vacuum tank may be that the slurry cuttings may freeze in cold weather environments such as Alaska, cold climate states and Canada, making it difficult to unload the slurry cuttings from the vacuum box. To solve this problem one solution may be to provide heat energy to keep the slurry cuttings from freezing. Slurry cuttings that are transported in a vacuum tank are commonly dumped from a vacuum tank by opening a tailgate attached to the vacuum tank. Repetitively opening the tailgate opening may dimmish the ability for the tailgate to seal to the vacuum tank. If the tailgate may be not heated slurry cuttings may freeze adjacent to the tailgate. Further, if the manner in which the tailgate seal s to the vacuum tank may be not configured for cold weather operations, the ability to seal may diminish.

Vacuum tanks must be removed from oil and gas well sites in a timely manner such to not impede the function of a drilling rig at an oil or gas well site. Such sites are limited in space and storing many vacuum tanks on the oil or gas well site may be not possible with current vacuum tank systems. Further portable slurry boxes often do not fit the requirements to be efficiently emptied at disposal facilities. In the warm summer months, poor road conditions cause excess wear on equipment. Transporting vacuum tanks with heating functions over summer roads during times of the year when the heating functions are unneeded unnecessarily causes wear on such equipment.

### SUMMARY

A tailgate assembly for a roll-off container according to one disclosed non-limiting embodiment of the present disclosure includes a tailgate; a hinge assembly mounted the tailgate, such that the tailgate is movable between an open position and a closed position about a hinge axis parallel to a top of the tailgate; a hydraulic actuation system operable to move the tailgate between the open position and the closed position; and a hydraulic lock assembly to maintain the tailgate in the closed position.

A further embodiment of any of the foregoing embodiments of the present disclosure includes, wherein the tailgate comprises a top, a bottom, a first side, and a second side, the top comprises a tailgate top support member, the bottom comprises a tailgate bottom support member, the first side comprises a tailgate first side support member, and the second side comprises a tailgate second side support member, each support member comprises a steel tube that is square in cross-section.

A further embodiment of any of the foregoing embodiments of the present disclosure includes, wherein a first lateral support member and a second lateral support member that extends between the bottom support member and the top support member.

A further embodiment of any of the foregoing embodiments of the present disclosure includes, a first hinge support member attached to the tailgate first side support member; a second hinge support member attached to the first lateral support member; a third hinge support member attached to the second lateral support member; and a fourth hinge support member attached to the tailgate second side support member.

A further embodiment of any of the foregoing embodiments of the present disclosure includes, wherein a first longitudinal support member that extends between the first side support member and the first lateral support member; and a second longitudinal support member that extends between the second side support member and the second lateral support member.

A further embodiment of any of the foregoing embodiments of the present disclosure includes, wherein a third lateral support member that extends between the first lateral support member and the bottom support member; and a fourth lateral support member that extends between the second lateral support member and the bottom support member.

A further embodiment of any of the foregoing embodiments of the present disclosure includes, wherein the hydraulic actuation system comprises: a first hydraulic cylinder pivotally attached to the first longitudinal support member, and a second hydraulic cylinder pivotally attached to the second longitudinal support member.

A further embodiment of any of the foregoing embodiments of the present disclosure includes, wherein the hydraulic lock assembly comprises the first lateral support member and the second lateral support member.

A further embodiment of any of the foregoing embodiments of the present disclosure includes a first latch attachment assembly and a second latch attachment assembly mounted to a reinforcement mounted to the roll-off container.

A further embodiment of any of the foregoing embodiments of the present disclosure includes, wherein reinforcement is mounted between a first and second roll-off rail of the roll-off container.

A further embodiment of any of the foregoing embodiments of the present disclosure includes, wherein the first latch attachment assembly is mounted transverse to the first lateral support member, and the second latch attachment assembly is mounted transverse to the second lateral support member.

A further embodiment of any of the foregoing embodiments of the present disclosure includes, wherein the first and second hydraulic cylinders are pivotally attached to the respective lateral support members along an axis which is parallel to the hinge axis by a pin and bushing arrangement.

A further embodiment of any of the foregoing embodiments of the present disclosure includes, wherein a lock pin attached to the first and second hydraulic cylinders via a pin that is retained therein by a safety clip, wherein the lock pin comprises a chamfered distal end, the chamfered distal end comprises three (3) surfaces including a slope portion, a flat portion, and a round portion.

A further embodiment of any of the foregoing embodiments of the present disclosure includes, wherein the lock pin of the first and second hydraulic cylinders are engageable with the respective first and second latch attachment assembly.

A further embodiment of any of the foregoing embodiments of the present disclosure includes, wherein the lock pin of the first and second hydraulic cylinders are engageable with the respective first and second latch attachment assembly.

A further embodiment of any of the foregoing embodiments of the present disclosure includes, wherein the first and second latch attachment assembly each comprise a striker bolt generally parallel to the reinforcement to which the lock pin of the first and second hydraulic cylinders engage.

A further embodiment of any of the foregoing embodiments of the present disclosure includes, wherein the tailgate is rectilinear.

A further embodiment of any of the foregoing embodiments of the present disclosure includes, wherein the tailgate opens to about 100 degrees with respect to the closed position.

A further embodiment of any of the foregoing embodiments of the present disclosure includes a seal located between the container and the tailgate when the tailgate is in the closed position an opening in the tailgate within the perimeter defined by the seal.

The foregoing features and elements may be combined in various combinations without exclusivity, unless expressly indicated otherwise. These features and elements as well as the operation thereof will become more apparent in light of the following description and the accompanying drawings. It should be appreciated that however the following description and drawings are intended to be example in nature and non-limiting.

### BRIEF DESCRIPTION OF THE DRAWINGS

These and other features and advantages of the present invention will become more readily appreciated as the same becomes better understood by reference to the following detailed description when considered in connection with accompanying drawings, wherein:

FIG. 1 is perspective view of a slurry box according to a disclosed non-limiting embodiment.

FIG. 2 is a schematic view of the slurry box mounted on a vehicle.

FIG. 3 is a schematic view of the slurry box being moved relative to the vehicle.

FIG. 4 is a top view of a slurry box.

FIG. 5 is a side view of a slurry box.

FIG. 6 is an end view of a slurry box opposite the tailgate end.

FIG. 7 is an end view of a slurry box with the tailgate in a closed position.

FIG. 8 is a schematic view of a slurry box showing removal of a power system from a mechanical bay.

FIG. 9 is a perspective view of a slurry box with the tailgate in an open position.

FIG. 10 is a sectional view of a jacketed flange.

FIG. 11 is a phantom view of the slurry box showing a set of warming tubes.

FIG. 12 is a perspective view of a tailgate for use with the slurry box according to one disclosed non-limiting embodiment.

FIG. 13 is a side view of the tailgate.

FIG. 14 is a partial phantom view of the tailgate showing a set of warming tubes.

FIG. 15A is a perspective view of a slurry box according to another disclosed non-limiting embodiment.

FIG. 15B is a first side view of the slurry box of FIG. 15A.

FIG. 15C is an end view of the slurry box of FIG. 15A.

FIG. 15D is a second side view of the slurry box of FIG. 15A.

FIG. 15E is a tailgate end view of the slurry box of FIG. 15A.

FIG. 15F is a top view of the slurry box of FIG. 15A.

FIG. 16A is a top view of the slurry box of FIG. 15A with the tailgate in an open position.

FIG. 16B is a side view of the slurry box of FIG. 15A with the tailgate in an open position.

FIG. 16C is a tailgate end view of the slurry box of FIG. 15A with the tailgate in an open position.

FIG. 17A is a perspective end view of the tailgate end assembly.

FIG. 17B is an exploded view of a hydraulic lock assembly of the tailgate end assembly.

### DETAILED DESCRIPTION OF THE ILLUSTRATED EMBODIMENTS

The slurry box as described in U.S. Nonprovisional patent application Ser. No. 17/531,989, filed Nov. 22, 2021, U.S. Nonprovisional patent application Ser. No. 17/396,403, filed Aug. 18, 2021, and the vacuum box as defined in U.S. Pat. No. 10,933,794 titled “Heated Slurry Transport System”, all contents of which are hereby incorporated by reference in its entirety.

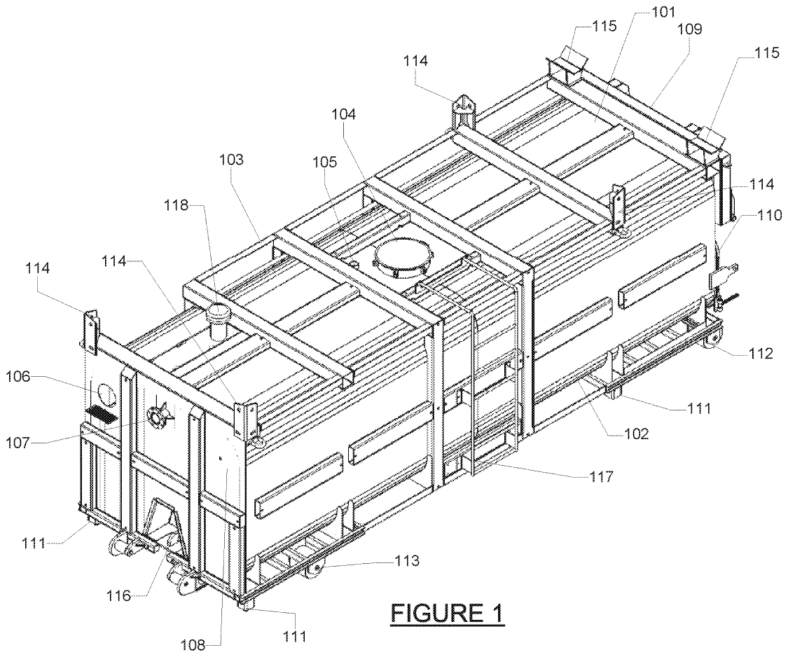

FIG. 1 is a perspective view of an example slurry box 101. The slurry box 101 includes a vacuum tank 102, a structure 103, and a mechanical bay 106. The slurry box 101 has a front 108 and a rear 109. The vacuum tank 102 may be attached to the structure 103. Attached to the vacuum tank 102 may be a manhole 104 which can be opened to allow for a person to enter the vacuum tank 102 or to load or unload the vacuum tank 102. The vacuum tank 102 may be configured such that it can withstand full or partial vacuum pressure. When the vacuum tank 102 may be placed under a vacuum from an external vacuum pump, material may be drawn into the vacuum tank 102. Mounted on the vacuum tank 102 may be a thermos-relief valve 105. Fluidly attached to the vacuum tank 102 may be one or more openings for loading and unloading. Each opening may be closed to fluidly seal the vacuum tank 102. In this example vacuum tank 102, a front pipe flange 107 may be shown.

The front pipe flange 107 can be used either for loading or unloading depending on requirements dictated by the worksite at which the slurry box 101 may be located. A vacuum pump may be fluidly attached to the front pipe flange 107 or any other pipe flange on the slurry box 101. The extent of the vacuum to be applied within the vacuum tank 102 may range all the way from relative atmospheric pressure to a full vacuum depending on the application at a worksite. In the event the front pipe flange 107 may be not being utilized at a job site, the front pipe flange 107 may be covered or may be connected to a valve which seal s the opening. Any opening on the vacuum tank 102, including the front pipe flange 107, may be jacketed with an exterior surface to allow a heated fluid flow to be circulated around an inner surface. For example, the front pipe flange 107 may have a five-inch inner surface and a six-inch exterior surface. Material may be loaded or unloaded through the five-inch inner surface of the pipe flange in the vacuum tank 102.

At the rear of the slurry box 101 a tailgate 110 may be attached to hinges on the slurry box 101 which allow for the tailgate 110 to be vertically opened. By attaching the tailgate 110 on the slurry box 101 such that it may be vertically opened, the slurry box 101 does not need additional lateral space. In many applications the slurry box 101 needs to be unloaded at sites which do not allow for excess lateral space around the slurry box 101. In some embodiments, the tailgate 110 may be sealed to the vacuum tank 102 when closed such that the vacuum tank 102 may maintain a vacuum pressure below atmospheric.

The structure 103 of the slurry box 101 may be attached to the vacuum tank 102 and thereby provide utility features such as a ladder to allow for access to the manhole 104 at the top of the slurry box 101. The structure 103 allows for the slurry box 101 to be stacked, lifted, moved, or transported. At the bottom of the slurry box 101 a rear wheel set 112 may be attached to the structure 103 near the rear 109. The rear wheel set 112 may be as commonly appreciated for use in roll-off containers. In embodiments, an optional front wheel set 113 may be provided. The rear wheel set 112 and the optional front wheel set 113 provide a wheel set.

The slurry box 101 may be stacked vertically when more than one slurry box 101 may be used. Many gas or oil well sites have limited space on which equipment can be placed and the ability to stack the slurry box 101 provides functionality. To provide this provides functionality, the structure 103 may include at least one stacking leg 111 and at least one stacking mount 114. In the embodiments, four stacking mounts and four stacking legs are provided such that each corner facilities functionality.

A wheel platform 115 may be attached to the structure 103 to support a wheel set when a slurry box 101 may be stacked. In the embodiment shown, a set of rear wheel platforms are demonstrated in a position that would support the rear wheel set 112 when stacked. The slurry box 101 may be lifted using D-rings and chains, a forklift, or any other lifting mechanism. When stacked, each respective stacking leg 111 fits into each respective stacking mount 114. The one or more stacking mounts collectively comprise a stacking mount system. The one or more stacking legs comprise a stacking leg system. The stacking leg systems fits together with the stacking mount system.

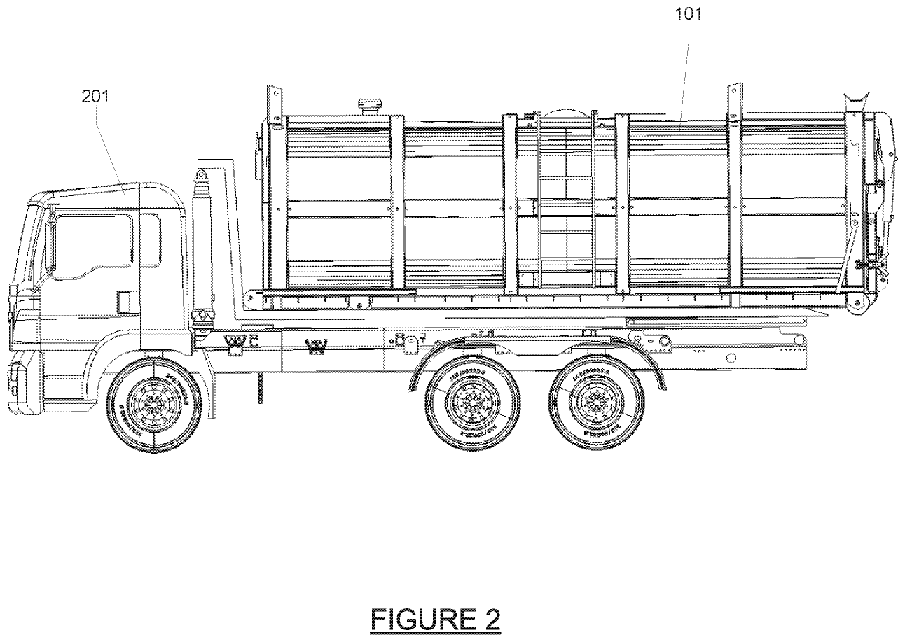

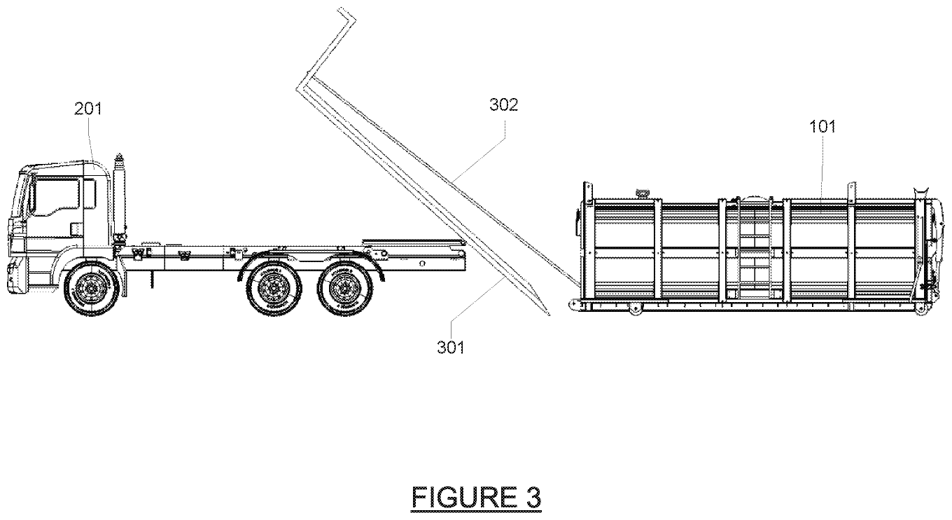

The slurry box 101 includes roll-off features to facilitate being transported on a vehicle 201. The slurry box 101 in embodiments may be a cable type roll-off container (FIGS. 2 and 3). A cable roll-off container may be pulled or placed on a vehicle such as a tilt-bed vehicle including a truck or trailer by a winch. A cable attached to the winch may be attached to a hook attachment 116 on the structure 103. The slurry box 101 may be then pulled onto the vehicle. In an alternative embodiment, the structure 103 may be built to allow for the hook attachment 116 to be attached near the top of the structure 103 to allow for a hook-loader type vehicle to pull the slurry box 101 onto the vehicle. For the purpose of this disclosure, a roll-off vehicle may be considered to be either a tilt-bed vehicle, a truck trailer combination, or a hook-loader type vehicle. A truck trailer combination type vehicle may be a vehicle 201 where a truck pulls a trailer, the trailer which may be a hook-loader type trailer or a tilt-bed type trailer. In a truck trailer combination the slurry box 101 may be pulled onto the trailer section of the truck trailer combination just as a slurry box 101 may be pulled onto a tilt-bed vehicle or a hook-loader type vehicle.

The slurry box 101 may be sized to fit onto the vehicle 201. The slurry box 101 may be built in a variety of sizes and shapes to accommodate different vehicles. An example slurry box 101 may be 2.26 meters (89 inches) wide by 7.37 meters (290 inches) long. A slurry box 101 with such dimensions would be compliant with certain various jurisdictional transportation requirements.

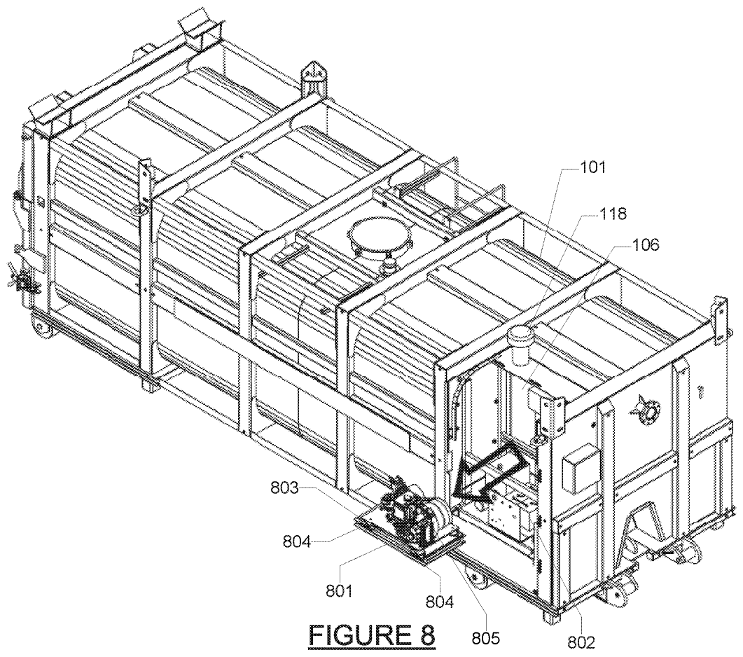

A mechanical bay 106 (also shown in FIG. 8) may be located within the slurry box 101. The mechanical bay 106 may be constructed as an element within the structure 103. In the mechanical bay 106, certain ancillary equipment may be located. A power unit 801 for providing heat energy to fluid within warming tubes and jacketed openings may be located in the mechanical bay 106. The power unit may also provide energy to power a hydraulic pump 805 to produce flow and pressure to operate various hydraulic functions. Such hydraulic functions include, but are not limited to, hydraulicly opening the tailgate 110. The power unit 801 may be a diesel engine with a fuel tank, an electric motor with a battery bank, or any other equipment as appreciated by one with ordinary skill in the art. The mechanical bay 106 may be designed to allow for the power unit 801 to be disconnected and removed when not needed. An exhaust port 118 may be positioned to allow for gas and air to circulate with the mechanical bay 106.

The power unit may be adapted to provide heat energy to fluid within warming tubes and jacketed openings. The warming tubes and jacketed openings contain a heating fluid which may be provided heat from the power unit by the use of a heat exchanger or other method understood by a person with ordinary skill in the art. The heating fluid within may be circulated through the warming tubes and jacketed openings for the purpose of distributing the heat energy. The heating fluid being circulated as a heated fluid flow.

The thermos-relief valve 105 may be such that if the pressure within the vacuum tank 102 increases, the pressure can be safely emitted from the tank. The thermos-relief valve 105 ensures that the vacuum tank 102 does not become under a positive pressure.

The slurry box 101 may be constructed of rigid materials, such as steel or aluminum. The structure 103 materials must be of requisite strength to allow for the slurry box 101 to be lifted, transported, with the vacuum tank 102 filed with materials. The vacuum tank 102 must be constructed in materials capable of withstanding negative pressure up to a full vacuum.

The slurry box 101 may be used in cold climates such as northern Alaska or other geographic locations which sustain extremely low temperatures. Cold regions may be referenced herein as the “arctic.” Temperatures may hover well below zero degrees and may maintain temperatures of −50 degrees Celsius. Steel may be adversely affected by low temperatures. For example, the tensile toughness may be affected, and safe working capacities may be reduced.

Part or all of the slurry box 101 may be constructed from certain types of heat-treated steels that undergo alloying. Alloying may include carbon, manganese, silicon, and other components.

The slurry box 101 may be constructed from a steel such as ASTM A537 Grade B. Traditionally most welded pressure vessels, storage tanks, and transportation equipment has been constructed from steels such as ASTM A516 and A442. A516 may be a common carbon steel used. A516 may show signs of fatigue in arctic conditions. A516 may be generally rated with a lowest usual service temperature of −45 degrees Celsius.

Many steels exhibit ductile fracture at elevated temperatures and a brittle fracture at low temperatures. A ductile fracture may be a type of fracture that may be characterized by plastic deformation and necking. The plastic deformation and necking typically occurs prior to actual fracture. A brittle fracture may be a type of fracture that may be characterized by an actual fracture that may be not proceeded by appreciable plastic deformation. Typically for steels, a lesser impact energy may be required to cause a brittle fracture relative to a ductile fracture. Further, as a ductile fracture occurs, impact energy may be absorbed by the steel undergoing deformation, whereas with a brittle fracture the steel actually fractures without appreciable plastic deformation such that impact energy may be not absorbed while the steel deforms.

The temperature at which a steel transitions from a ductile fracture to a brittle fracture may be known as the ductile-brittle transition. The ductile brittle transition may be a temperature at which the impact energy needed to cause an actual fracture passes below a predetermined value. A test understood by persons in the industry may be the Charpy impact test. The Charpy impact test establishes the predetermined value to be 40 Joule.

Charpy impact test may be sometimes referred to as the Charpy V-notch test in the steel industry. The Charpy impact test may be a standardized high strain-rate test that involves striking a specimen with a value of impact energy.

Some grades of A516 may have a ductile brittle transition of around −30 degrees Celsius. Some grades of A537 may have a ductile brittle transition less than the arctic temperatures of −50 degrees Celsius. A537 in some grades may be rated for a lowest usual service temperature of −60 degrees Celsius. By selecting a steel that has a ductile brittle transition less than the arctic temperatures, the steel may be more suitable for use in the arctic. Steel, such as A516, may effectively shatter in a brittle failure in extremely cold temperatures which are beneath the ductile brittle transition temperature.

Traditionally, roll-off containers have not been constructed from steels with a ductile brittle transition temperature less than −30 degrees Celsius. Typically, roll-off containers have been long constructed out of steels similar to A516. Vacuum trucks are a type of truck that may be generally includes of a vacuum tank and a vacuum pump which are permanently mounted to a truck frame. Vacuum trucks have traditionally been used to remove slurry cuttings from oil rig sites. Vacuum trucks traditionally have not been constructed from steels with a ductile brittle transition temperature less than −30 degrees Celsius. Typically, vacuum trucks have been long constructed out of steels similar to A516.

Steels with a ductile brittle transition less than −30 degrees Celsius have been used to some extent for stationary tanks in the arctic. Identifying the specific characteristics of a suitable steel including the ductile brittle transition temperature may be highly technical as there are many variations of steels. The selection of A537 Grade B may be based on ductile brittle transition temperature, strength of material, fatigue limits, and workability for construction. A537 may be a difficult steel to use for equipment construction and specialized welding and manufacturing techniques may be required. More traditional steels such as A516 are less expensive than steels like A537. Given this cost constraint, those in the industry have been motivated to use less costly steels like A516.

Many different steels are engineered specifically for service at low temperature (about −100 °C), selecting the optimum material calls for thorough understanding of the application and knowledge of the mechanical properties that each grade provides. It isn't as simple as to simply choose a steel type based simply on temperature.

An additional consideration when selecting a suitable type of steel for application on the slurry box 101 may be fatigue limits. At low temperatures, systems are usually subjected to dynamic loads, and structural members to cycle stresses. Examples include the vacuum tank 102 that frequently undergo pressure changes and mobile equipment that experience extreme stress imposed by packed snow or high winds. Other considerations include heat conductivity and thermal expansion.

The slurry box 101 may alternatively or additionally be constructed such that the vacuum tank 102 may hold a positive pressure. A positive pressure may be a pressure within the vacuum tank 102 that may be greater than the atmospheric surrounding the vacuum tank 102. A vacuum pressure may be a pressure within the vacuum tank 102 that may be less than the atmospheric surrounding the vacuum tank 102. A tank that may be capable of holding a positive pressure may be referenced as a pressure vessel. The vacuum tank 102, when constructed to hold a positive pressure, in this application, may be called a pressure vessel.

In order to construct the slurry box 101 to be capable of holding a positive pressure, the thermos-relief valve 105 will be removed from such embodiment. The thermos-relief valve 105 may be replaced with a pressure relief valve. A pressure relief valve may be a valve that releases excess pressure. A pressure relief valve may be a safety mechanism to limit the pressure in the vacuum tank 102. A pressure relief valve can be set to release pressure ranging anywhere from just over the pressure surrounding the vacuum tank 102 to pressures exceeding 275.8 kPa (40 psig). Each opening in the vacuum tank 102 would need to be constructed such to be able to hold a positive pressure.

Construction may be such that the vacuum tank 102 may hold the desired level of positive pressure. For example, an operator may desire the vacuum tank 102 to hold a positive pressure of 206.8 kPa (30 psig). When the openings are seal ed, the openings and the vacuum tank must hold the desired positive pressure when configured to hold a positive pressure. If used, the pressure relief valve must be configured to allow for a greater pressure than the desired pressure.

Example standards which may be followed in constructing the vacuum tank 102 for positive pressure include what may be commonly referenced as a DOT 407 or 412 cargo tank. A DOT 407 cargo tank may be described in detail in 49 CFR § 178.347. A DOT 412 cargo tank may be described in detail in 49 CFR § 178.348.

When configured as a pressure vessel, slurry cuttings held in the vacuum tank 102 may be forced out of the vacuum tank 102 using positive pressure. Slurry cuttings may be forced from the vacuum tank 102 using pressure when the slurry cuttings contain enough water to be cable of flowing. However, suppose the slurry cuttings are solid or do not contain enough water. In that case, positive pressure may not be sufficient to force the solid slurry cuttings out of the vacuum tank 102 through openings. Unloading the slurry cuttings may be completed using positive pressure if the slurry cuttings are capable of flowing out of an opening.

With reference to FIG. 2, the slurry box 101 may be mounted on a vehicle 201. The vehicle 201 may be a tilt-bed roll-off type vehicle. The slurry box 101 may be shown as a cable type roll-off embodiment. Other types of vehicles and roll-off embodiments may be used as commonly appreciated by a person of ordinary skill in the art. The vehicle 201 configured as a tilt-bed roll-off type vehicle may be capable of pulling the slurry box 101 onto the vehicle 201 and capable of causing the slurry box 101 to be displaced from the vehicle 201. The vehicle may cause a slurry box 101 to be displaced from the vehicle 201 and then pull a different slurry box 101 onto the vehicle 201. A well site may have multiple slurry boxes placed on site.

With reference to FIG. 2, the example slurry box 101 is shown displaced from the vehicle 201. The vehicle 201 in the example figure shows a tilt-bed roll-off type vehicle. The vehicle 201 may be shown with a tilt-bed 301 and a cable 302. The cable 302 can be used to pull the slurry box 101 onto the tilt-bed 301.

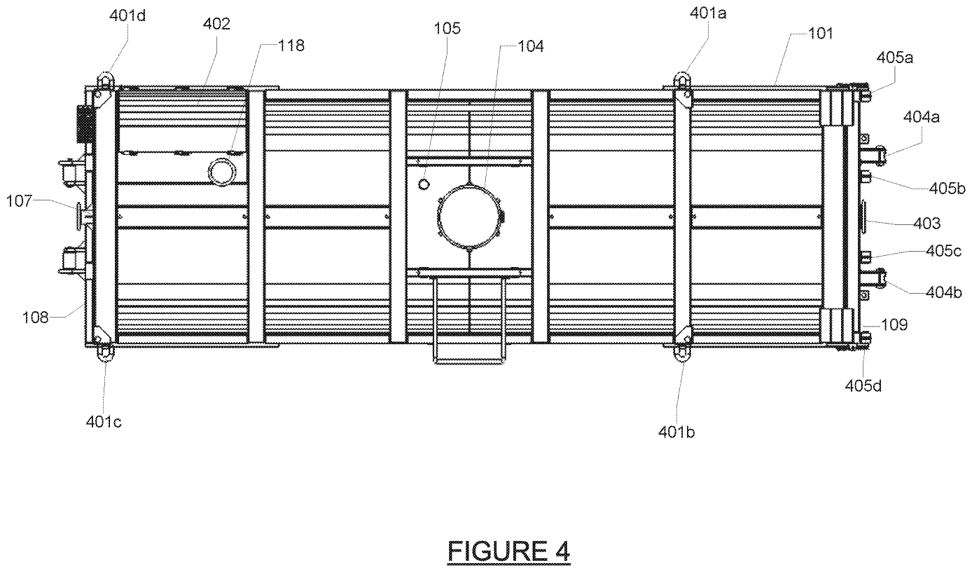

With reference to FIG. 4, the top of the slurry box 101 includes the manhole 104, the thermos-relief valve 105, the exhaust port 118, as well as other slurry box 101 features. A set of lift hooks 401 are shown attached to the structure 103. The lift hooks 401 may be positioned to allow for the slurry box 101 to be picked up. Near the front 108 of the slurry box 101 the mechanical bay 106 may be shown. Access to the mechanical bay 106 may be had via a bay cover 402.

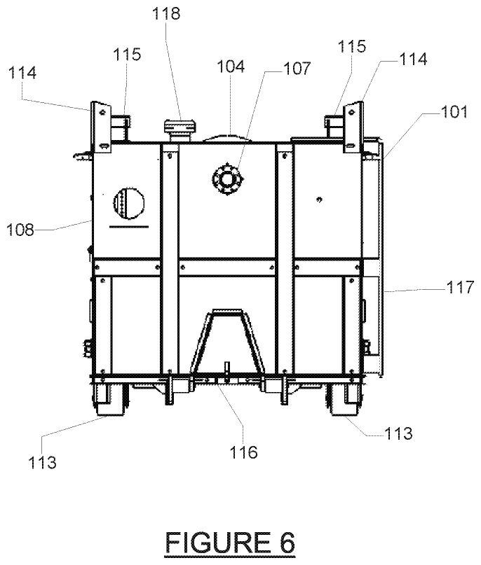

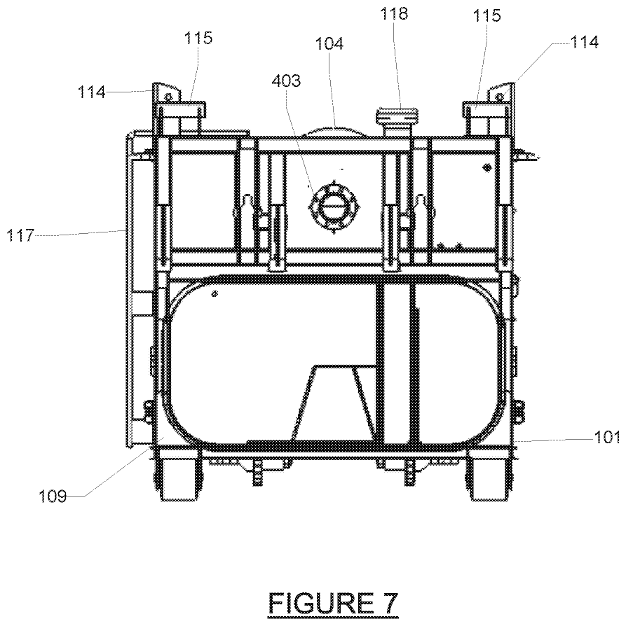

At the front 108 (FIG. 6) of the slurry box 101 a front pipe flange 107 can be seen. At the rear 109 (FIG. 7) of the slurry box 101 a rear pipe flange 403 can be seen. Like the front pipe flange 107, the rear pipe flange 403 may be jacketed to allow for a heated fluid flow to be circulated around the inner surface such to keep the material within the vacuum tank 102 and within the jacketed flange from freezing.

With reference to FIG. 6, the driver-side of the slurry box 101 is shown. Shown attached to the structure 103 may be the front wheel set 113 and a rear wheel set 112. A stacking leg 111 may be attached near the front 108 of the slurry box 101 and near the rear 109. A stacking mount 114 may be attached near the front 108 of the slurry box 101 and near the rear 109. A rear wheel platform 115 may be shown near the rear 109 of the slurry box 101.

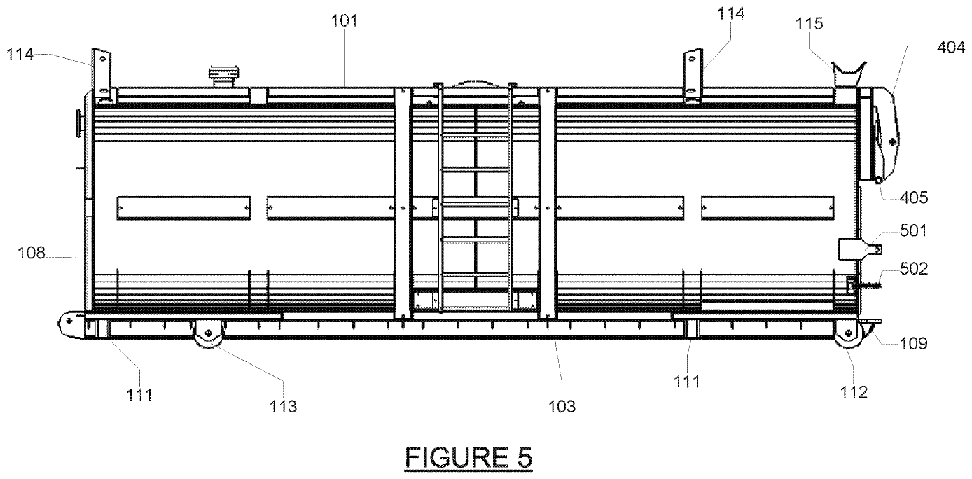

At the rear 109 of the slurry box 101, a hydraulic mount 404 may be shown. In FIG. 5 the tailgate 110 and hydraulic cylinders are removed from the drawing. At least one tailgate hinge 405 may be shown. A latch receiver 501 may be attached to the vacuum tank 102. The latch receiver 501 interfaces with the tailgate 110 such that when the tailgate 110 may be in the closed position, a hydraulic latch mounted on the tailgate 110 secures into the latch receiver 501. When the hydraulic latch may be secured into the latch receiver 501, the tailgate 110 may not be moved from the closed position. The closed position may be when the tailgate 110 may be secured to the vacuum tank 102 and a fluid seal may be made between the vacuum tank 102 and the tailgate 110. A manual latch 502 may be attached to the vacuum tank 102. The manual latch 502 in this example embodiment comprises a threaded bolt and a wingnut secured on the threaded bolt when the tailgate 110 may be in the closed position. The wingnut in the example, may be to be removed by an operator.

With reference to FIG. 6, the front 108 of the slurry box 101 includes the front pipe flange 107 near the top of the slurry box 101. Mounted near the top of the slurry box 101 may be at least one stacking mount 114. In the figure, two stacking mounts are displayed. At the bottom of the slurry box 101 at least one front wheel set 113 may be shown. In the example figure, two wheels are shown. A hook attachment 116 may be shown in the figure. Shown in the figure may be a partial view of a set of rear wheel platforms, a partial view of the manhole 104, and the exhaust port 118. On the side of the slurry box 101 can be seen a side profile of the ladder 117.

With reference to FIG. 7, the rear 109 of the slurry box 101 may include at least one rear wheel platform 115. Shown in the figure may be two rear wheel platforms. Alternatively, the slurry box 101 may be configured without any rear wheel platforms. At least one stacking mount 114 may be attached to the slurry box 101. In the figure two stacking mounts are displayed. On the side of the slurry box 101 can be seen a side profile of the ladder 117. The manhole 104 and the exhaust port 118 may be located at the top of the slurry box. The manhole 104, the ladder 117, and the exhaust port 118 are not essential in all embodiments of the invention disclosed in this description. An optional rear pipe flange 403 may be shown.

With reference to FIG. 8, the slurry box 101 shows how power unit 801 can be removed. The slurry box 101 may be shown with a bay cover 402 opened such to allow access to the mechanical bay 106. The exhaust port 118 allows for exhaust to be vented from the mechanical bay 106. In the example figure a diesel engine may be shown as the power unit 801. The power unit 801 may be connected to a hydraulic pump to produce hydraulic pressure, connected to a pump to provide a fluid flow through the warming tubes, and configured to provide heat energy to the fluid within the warming tubes. The diesel engine may be substituted with an alternative power unit device. Such alternatives include but are not limited to an electric motor, a gasoline engine, a turbine, or any other such device appreciated by one with ordinary skill in the art. The power unit 801 uses an energy source 802 attached to the slurry box 101. The energy source 802 may be electrical energy, chemical energy, gasoline, diesel, or other such energy source 802 which may be compliant with the relevant power unit 801.

The power unit 801 may be configured on a skid 803 which allows for the power unit 801 to be removed from the mechanical bay 106. The skid 803 may be configured with one or more forklift pockets 804 to allow for the skid 803 and items to which it may be attached to be removed from the mechanical bay 106 using a forklift. In alternative embodiments, the hydraulic pump and/or other components may be attached to the skid 803 to allow for removal from the mechanical bay 106. Any type of quick disconnect connectors understood by a person of ordinary skill in the art may be used to connect the skid 803 and items to which it may be attached to warming tubes, hydraulic lines, electrical connections, and other elements on the slurry box 101.

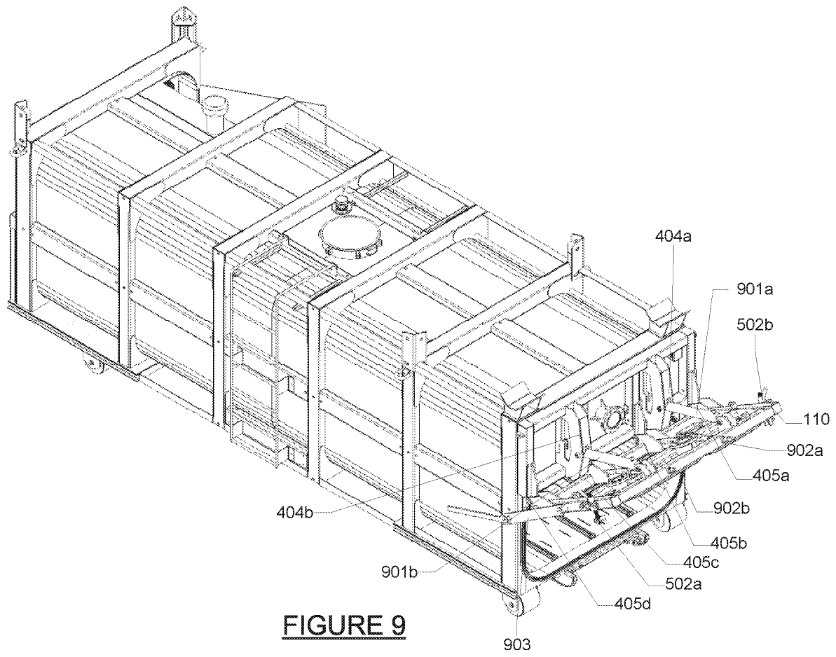

With reference to FIG. 9, the rear 109 of the slurry box 101 includes a hydraulic mount 404a, 404b (two shown). Each hydraulic mount 404a, 404b provides a pivotal attachment for the hydraulic cylinder. The hydraulic cylinder may be connected on the opposite end to the tailgate 110. When hydraulic pressure may be delivered to the hydraulic cylinder, the tailgate 110 may be opened or closed by the retracting or extending of the hydraulic cylinder. The tailgate 110 may be attached to the slurry box 101 with at least one tailgate hinge 405 (four shown).

The tailgate 110 may be opened using hydraulic force or any other force. In some embodiments a hydraulic actuation system 900 with at least one hydraulic cylinder 901 (two shown) may be used to open and close the tailgate 110. In the figure, two hydraulic cylinders are connected between the tailgate 110 and each hydraulic mount 404. The tailgate 110 may be attached to the vacuum tank 102 by at least one tailgate hinge 405. The one or more hinges may be attached to the structure 103 or may be attached to the vacuum tank 102. The tailgate 110 closes such that it may be attached to the vacuum tank 102 and fluidly seal the vacuum tank 102 when it may be closed. In the example embodiment a set of four hinges are shown which comprise the tailgate hinge 405. The tailgate hinge 405 may be configured such that its axis may be parallel to the bottom of the structure 103. The tailgate 110 pivots on the tailgate hinge 405 such that it opens vertically.

When the tailgate 110 may be moved to the closed position such that the tailgate 110 fluidly seals the vacuum tank 102, the tailgate may be secured against the vacuum tank 102. The tailgate 110 can be secured against the vacuum tank 102 using a latch receiver 501, manual latch 502, or any other method appreciated by a person with ordinary skill in the art. In FIG. 9 an alternative type of manual latch 502 may be shown. A vertical latch 902 may be used to secure the tailgate 110. The vertical latch 902 in this embodiment may be functioned by a hydraulic force.

A safety brace 903 may be attached to the structure 103 to ensure the tailgate 110 may be mechanically maintained in an open position such that the tailgate 110 may not close due to the force of gravity or due to hydraulic force from the hydraulic cylinder. The safety brace 903 may be hingedly attached to the structure 103 or vacuum tank 102 and may be configured such that the tailgate 110 may not close when the safety brace 903 may be positioned against the tailgate 110.

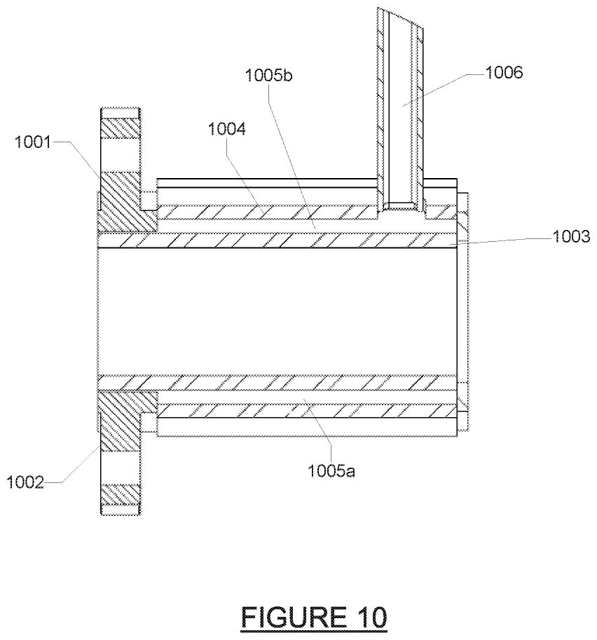

With reference to FIG. 10, an example jacketed flange 1001 such as for the front pipe flange 107, a rear pipe flange 403, or any other opening in the vacuum tank 102 incudes a flange face 1002, an inner surface 1003, an exterior surface 1004, and a warming channel 1005a, 1005b. Attached to the jacketed flange 1001 may be a warming tube 1006. The warming tube 1006 conveys the heated fluid flow to the jacketed flange 1001 warming channel 1005a, 1005b. The heated fluid flow may be fluid which was heated by the power unit 801. The warming tube 1006 may be connected from any angle or location. The heated fluid flow which may be conveyed to the warming channel 1005a, 1005b maintains a temperature which causes any material located within the area contained by the inner surface 1003 to remain above a freezing temperature. The inner surface 1003 may be essentially encloses an opening which allows material to flow through. The exterior surface 1004 encloses the inner surface 1003.

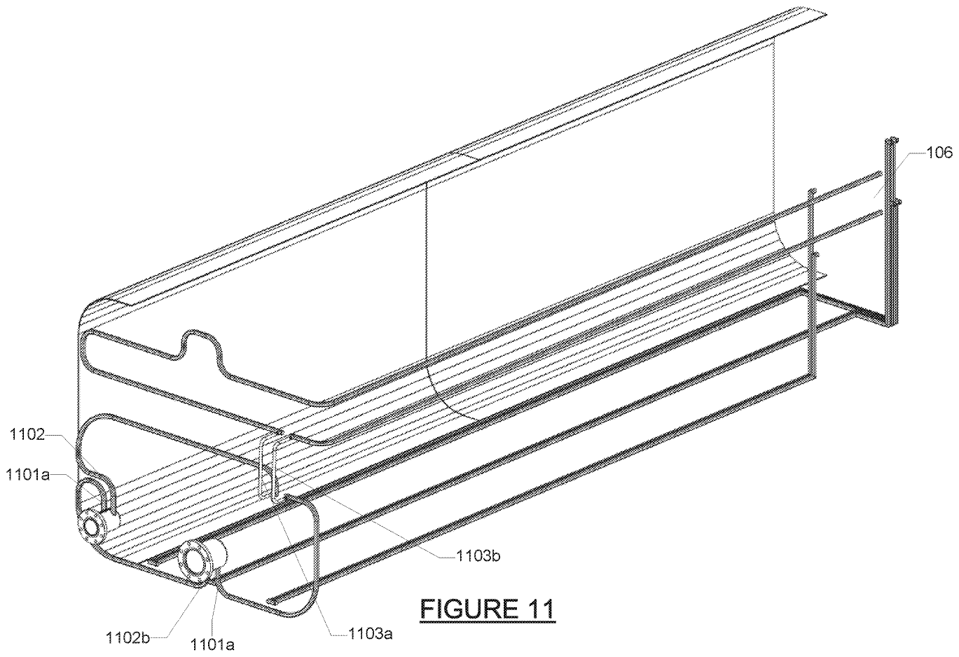

With reference to FIG. 11, an example warming tube system is shown, however, not all potential warming tubes within the system are specifically illustrated. Shown are two jacketed flanges which represent the location at which the tailgate 110 would be positioned when closed. The two shown flanges would be attached to the tailgate 110. A supply warming tube 1101 and an exit warming tube 1102 may be attached to each of the jacketed flanges. Hinge warming tubes 1103 are used to connect warming tubes in the tailgate 110 to warming tubes attached to the vacuum tank 102. Warming tubes are configured to be positioned such to connect to connectors 1105 (illustrated schematically) in the mechanical bay 106.

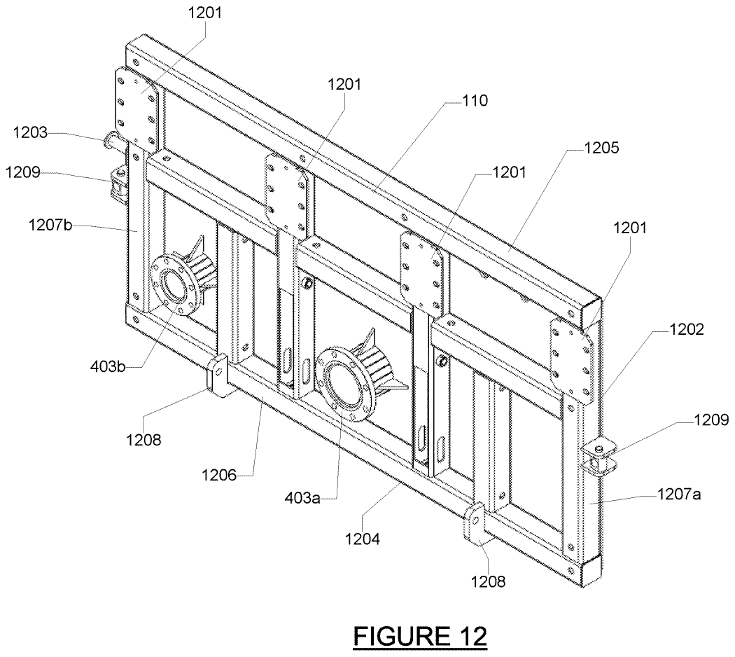

With reference to FIG. 12, the tailgate 110 is shown separately and not attached to the vacuum tank 102. The tailgate 110 may include a tailgate assembly and a tailgate warming tube loop 1303. The structural members may be metal square tubing attached together to create the shape of the tailgate 110. Structural members may be fastened together with fasteners, welded, or other devices. The interior surface 1202 may be attached to the structural members.

The tailgate 110 may seal to the vacuum tank 102 such that a seal 1210 may be located between the vacuum tank 102 and the tailgate 110. The seal 1210 may be an elastomer with viscoelasticity. For example, the seal 1210 may be natural or synthetic rubber. The seal 1210 fills any voids between the vacuum tank 102 and tailgate 110 such that a vacuum can be pulled in the vacuum tank 102 or such that the vacuum tank 102 may hold a positive pressure. The seal 1210 may be configured to attach to the tailgate 110 or the vacuum tank 102. For example, when the tailgate 110 opens, the seal 1210 may remain attached to the tailgate 110 and move away from the vacuum tank 102.

The tailgate 110 has a top 1205, a bottom 1206, a first side 1207a, and a second side 1207b. The first side 1207a and the second side 1207b may be referenced as a side or the sides. The tailgate 110 has a perimeter. The perimeter may be defined by the top 1205, the bottom 1206, the first side 1207a, and the second side 1207b. The seal 1210 may match the shape of the perimeter. The tailgate 110 as shown in FIG. 12 may be rectangular, though the tailgate 110 may be configured in any shape that conforms to the vacuum tank 102.

The tailgate 110 may also include openings. The openings may include jacketed openings. The jacketed openings may include one or more rear flanges. There may be a first rear flange 403a and a second rear flange 403b. Other openings may be configured through the tailgate 110. The first rear flange 403a and the second rear flange 403b may be attached to the tailgate assembly or the interior surface 1202. The first rear flange 403a and the second rear flange 403b extend through the interior surface 1202 such that material may pass through first rear flange 403a or the second rear flange 403b into or out of the vacuum tank 102.

The tailgate 110 may have a hinge mount 1201. There may be one or more hinge mounts. Alternatively, the tailgate 110 may be configured without any hinge mount 1201 and each tailgate hinge 405 may be attached to the perimeter or other tubing comprising the tailgate 110. A tailgate hinge 405 may be secured to a hinge mount 1201 by fasteners, welding, or other relevant methods. The tailgate 110 may be attached to the vacuum tank 102 by at least one tailgate hinge 405. One portion of the tailgate hinge 405 may be attached to the tailgate 110 hinge mount 1201 whereas another portion of the tailgate hinge 405 may be attached to the vacuum tank 102; the hinged function between the two portions to allow the tailgate 110 to open and close in a vertical manner for space constraints.

The tailgate 110 may also include one or more hydraulic attachments 1208. The hydraulic attachment 1208 may be a location on the tailgate 110 at which the hydraulic cylinder 901 may be hingedly attached. The hydraulic attachment 1208 may extend from the tailgate 110 to allow for clearance between the tailgate 110 and the hydraulic cylinder 901. More than one hydraulic cylinder 901, hydraulic attachment 1208, and hydraulic mount 404 may be used.

The tailgate 110 may also include one or more manual latches. A manual latch 502 may be a manual latch base 1209 and a manual latch hook. The manual latch base 1209 may be configured to attach to one or both sides of the tailgate 110. A manual latch hook may be attached to the manual latch base 1209 which extends toward the structure 103. An example manual latch hook may be a threaded rod which has a wing nut on a first end or the threaded rod and a hook on the second end of the threaded rod. The hook may secure to the structure 103 or vacuum tank 102 when the wing nut may be tightened. When the hook is secured to the structure 103 or vacuum tank 102, the tailgate 110 may be effectively securely closed. The wingnut in the example, may be manually adjusted by an operator. The tailgate 110 can be secured against the vacuum tank 102 using a latch receiver 501, manual latch 502, and/or other device.

The slurry box 101 may be configured with a safety system to ensure the tailgate 110 may not close due to gravity, hydraulic force, or other force once opened. This safety system may ensure that a worker isn't accidentally injured by unexpected movement of the tailgate 110 or trapped in the vacuum tank 102. The safety system may comprise of a safety brace 903 and a safety stop 1203. The safety brace 903 may be hingedly attached to the structure 103 or vacuum tank 102 and may be configured such that the tailgate 110 may not close when the safety brace 903 may be positioned against the tailgate 110. The attachment on the tailgate 110 upon which the safety brace 903 may be positioned against may be the safety stop 1203. The safety stop 1203 may be connected to the perimeter of the tailgate 110.

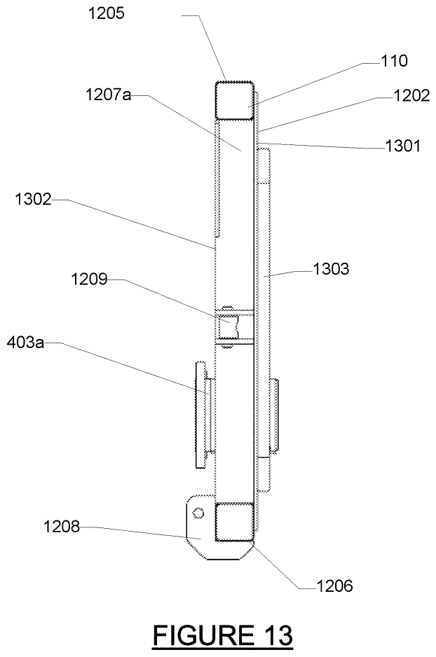

With reference to FIG. 13, the tailgate 110 has an interior surface 1202 with an interior side 1301 and an exterior side 1302. The interior side 1301 may be the portion of the tailgate 110 that may be exposed to the interior of the vacuum tank 102 when the tailgate 110 may be closed. The exterior side 1302 may be the side of the tailgate 110 that may be exposed to the atmosphere when the tailgate 110 may be closed. Attached on the interior side 1301 may be a tailgate warming tube loop 1303. The tailgate warming tube loop 1303 may extend from the interior side 1301 to the exterior side 1302 in order to connect with hinge warming tubes 1103.

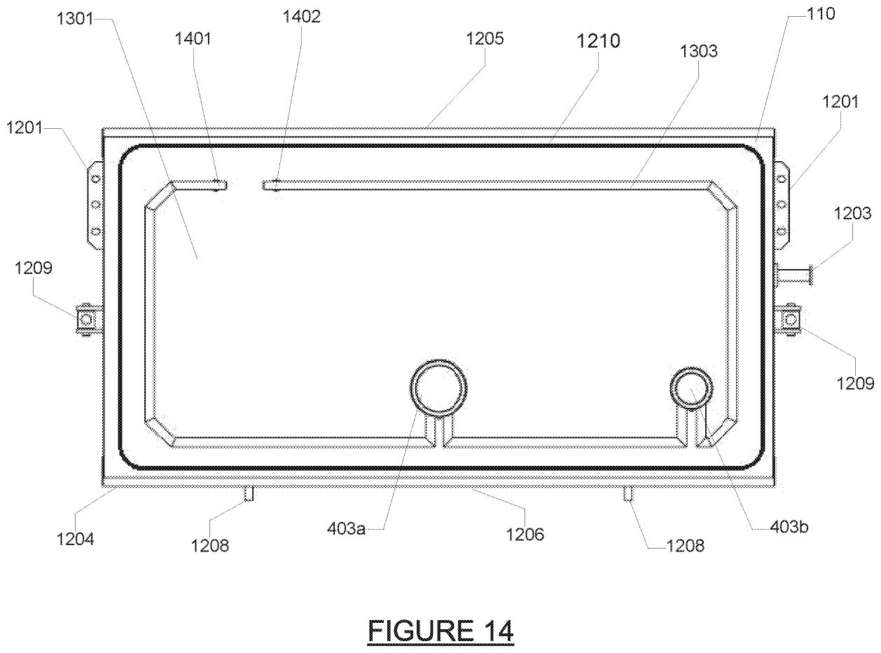

FIG. 14 may be a view of an example tailgate 110 from an inside perspective. The interior side 1301 may be shown in the figure. The figure demonstrates the perimeter as defined by the top 1205, the bottom 1206, the first side 1207a, and the second side 1207b. A tailgate warming tube loop 1303 shape generally follows the shape formed by the perimeter. The tailgate warming tube loop 1303 may be offset from the perimeter. Heated heating fluid, in the form of a heated flow, may enter the tailgate warming tube loop 1303 at the entrance 1401, flow through the tailgate warming tube loop 1303, the jacketed flanges, and exits the tailgate warming tube loop 1303 through the exit 1402. The exit 1402 and entrance 1401 may be reversed. The tailgate warming tube loop 1303 may be connected to one or more jacketed flanges.

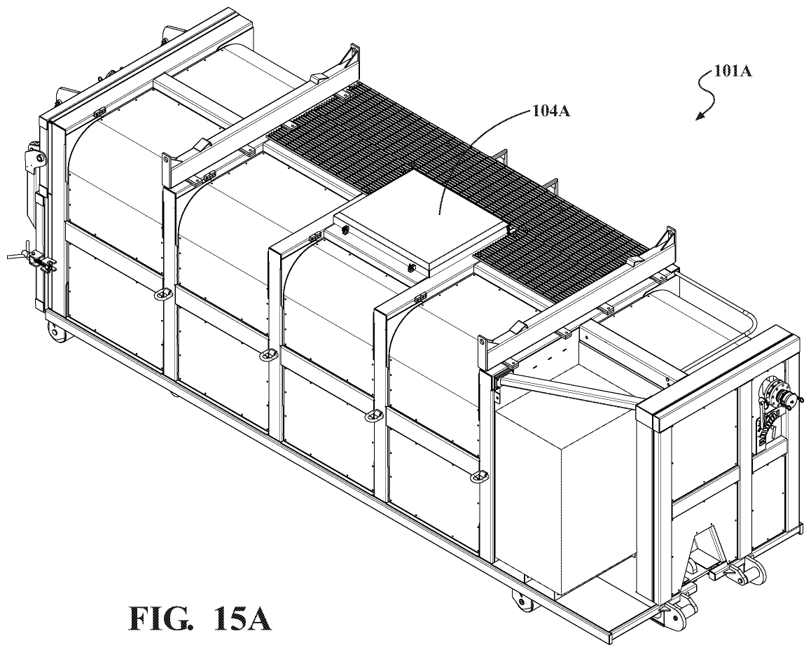

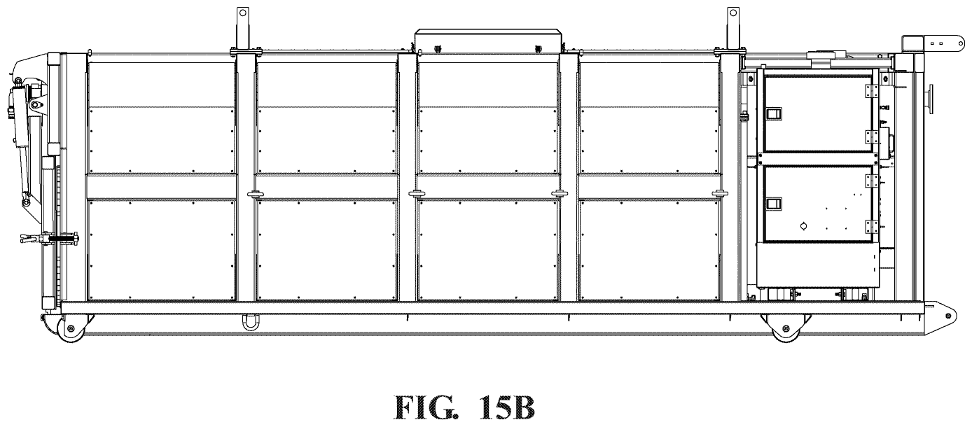

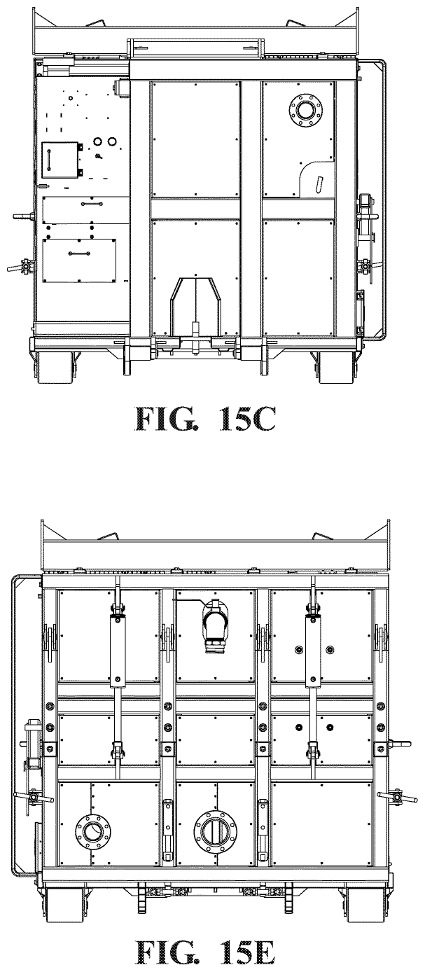

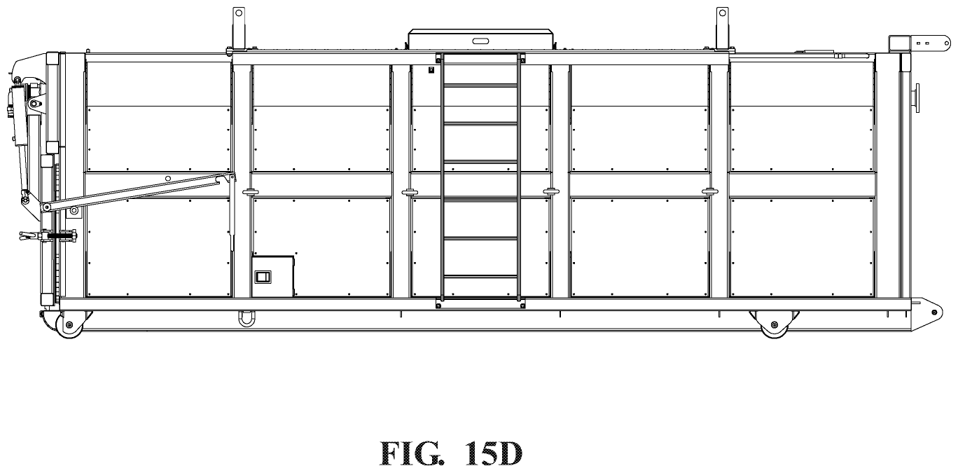

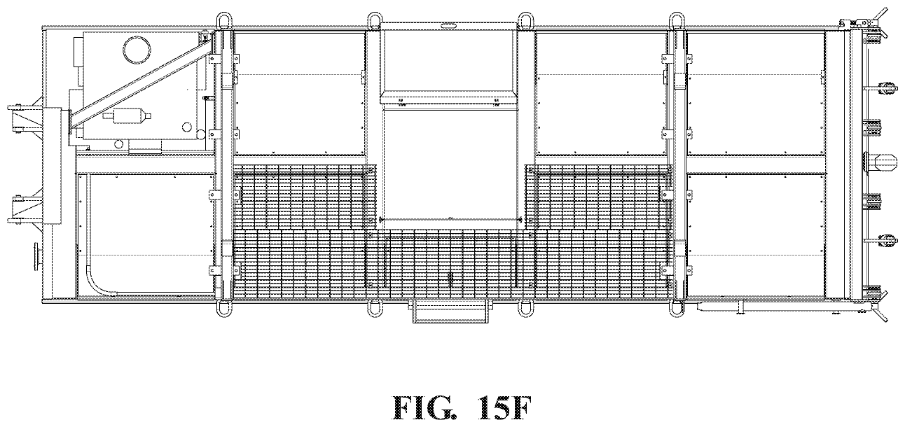

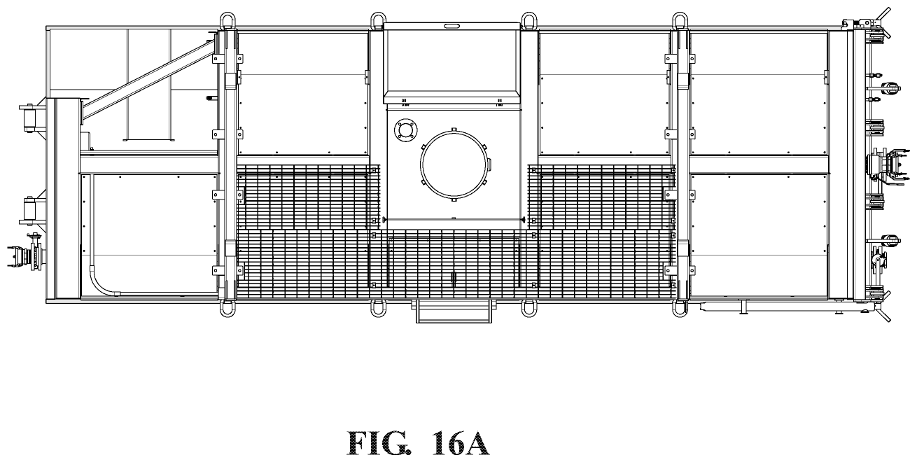

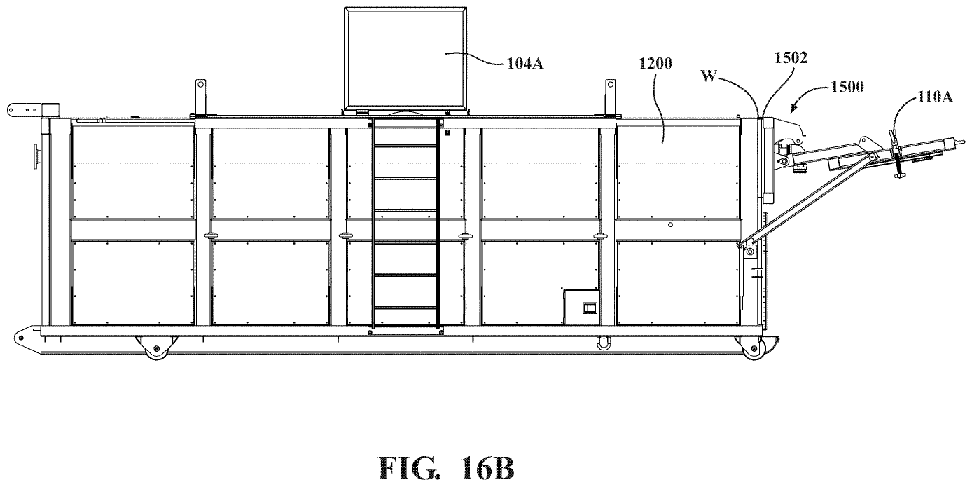

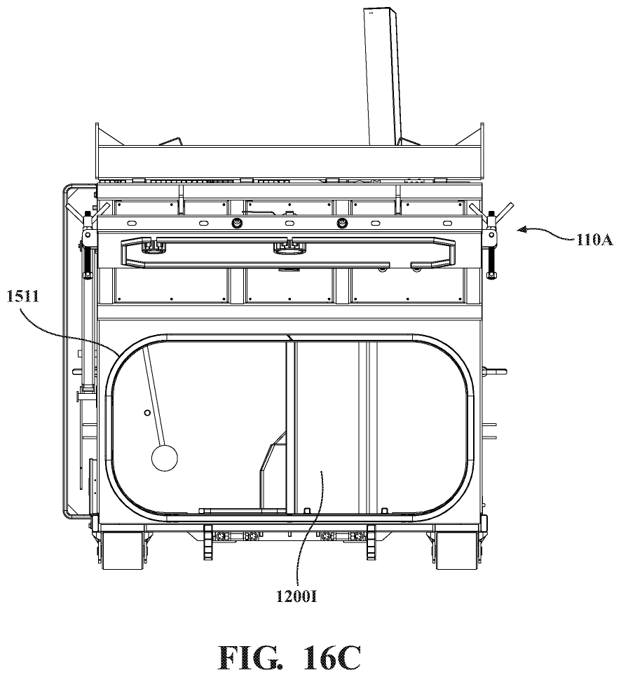

With reference to FIG. 15A-15F, a slurry box 101A according to another disclosed non-limited embodiment includes a tailgate 110A and a manhole 104A (both shown open in FIG. 16A-16C) which may be opened and closed to access an interior 1200I (FIG. 16C) of a container 1200 such as a cable type roll-on, roll-off container. Alternatively, the container 1200 may include, or be provided as, a vacuum container that can be depressurized to a pressure below atmosphere.

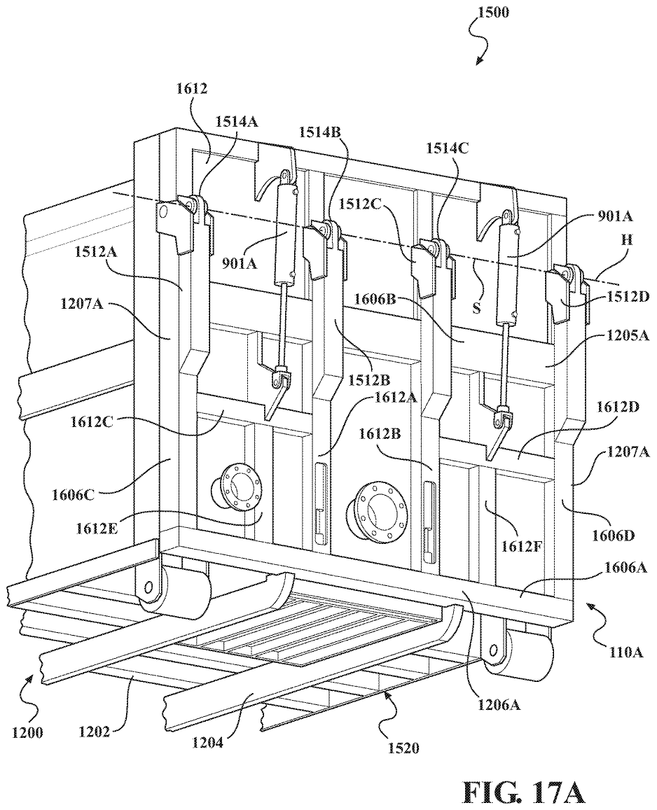

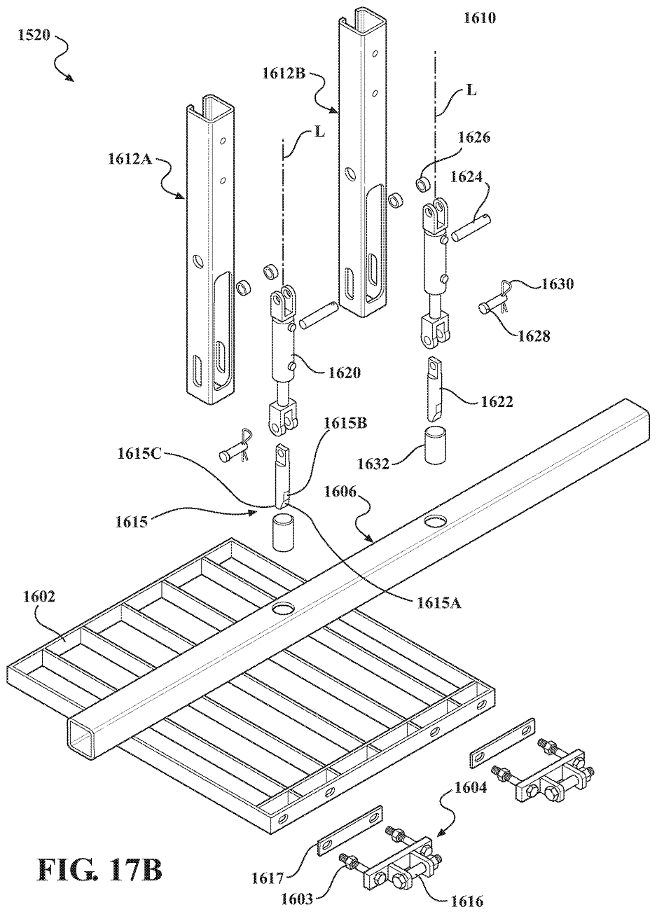

With reference to FIG. 17A, a hydraulically lockable tailgate end assembly 1500 with the tailgate 110A may be detailed. In embodiments, the tailgate 110A may be retrofit to conventional steel shipping containers such as CONEX, and other such boxes by welding the entire tailgate end assembly 1500 that includes the tailgate 110A thereto. That is, in embodiments, the original shipping container doors, and/or the entire door end of the shipping container which typically has two doors on vertical hinges, may be removed such as by disassembly and/or by cutting such that a square tailgate end panel 1502 of the tailgate end assembly 1500 that includes the tailgate 110A may be welded (shown schematically at W (also shown in FIG. 16B) as a unit to the open end of the container 1200. A conventional steel shipping containers such as CONEX is thus readily converted to having a hydraulically lockable tailgate end assembly 1500 with the mechanical bay 106 as described above. Alternatively, the tailgate end assembly 1500 may be integrated as original equipment with the slurry box 101A.

The tailgate 110A has a top 1205A, a bottom 1206A, a first side 1207Aa, and a second side 1207Ab. The tailgate 110A in this embodiment, as in FIG. 12, may have a rectangular periphery, to close an opening 1511 which, in this embodiment, may be generally racetrack shaped (FIG. 16C), e.g., generally rectangular with rounded corners. In embodiments, the tailgate 110A may open to about 100 degrees (FIG. 16B) with respect to the closed position.

A seal 1210 (also shown in FIG. 14) may match the shape of the opening 1511 within the perimeter of the tailgate 110A (FIG. 16C). The tailgate 110A and the opening 1511 may be configured in any shape that conforms to the container.

The tailgate bottom 1206A may be at least partially defined by the tailgate bottom support member 1606A. The top 1205A, the first side 1207Aa, and the second side 1207Ab may each be respectively defined in part by a corresponding support member 1606B, 1606C, 1606D which may may be formed of steel tube that may be square in cross-section to provide structural strength.

Lateral support members 1612A, 1612B may extend between the bottom support member 1606A and the top support member 1606B. Longitudinal support members 1612C, 1612D may extend between the side support members 1606C, 1606D and the lateral support members 1612A, 1612B to form an essentially “T” shape with respect to the bottom support member 1606A. Third and fourth lateral support member 1612E, 1612F may extend between the respective longitudinal support members 1612C, 1612D. The support members may be formed of steel tube that may be square in cross-section.

A hinge assembly 1510 may include a multiple of hinge support members 1512A, 1512B, 1512C, 1512D may be welded to the respective side support member 1606C, lateral support members 1612A 1612B, and the side support member 1606D. The hinge support members may be formed of steel tube that may be square in cross-section. The hinge support members 1512A, 1512B, 1512C, 1512D are pivotally mounted a respective set of four hinge attachments 1514A, 1514B, 1514C, 1514D mounted to the container end panel 1612 to form a hinge axis H parallel to the bottom support member 1606A. The tailgate 110A pivots on the tailgate hinge axis H such that the tailgate 110A opens vertically with respect to the bottom 1202B of the container 1200 (FIG. 16A-16C). The tailgate 110A may be opened using hydraulic force via at least one hydraulic cylinder 901A (two shown) as discussed above.

The tailgate end assembly 1500 generally includes a hydraulic lock assembly 1520 that includes a reinforcement 1602, a latch attachment assembly 1604 (two shown), a tailgate bottom support member 1606, and a hydraulic lock assembly 1610 (two shown).

The reinforcement 1602, in embodiments, may be a grill or other such structure that may be attached to a bottom 1202B of the container 1200. In embodiments, the reinforcement 1602 may be attached via welding between the roll-off rails 1204 via welding or other attachment. The roll-off rails 1204 may extend along at least a portion of the bottom 1202B thereof. The roll-off rails 1204 may be formed as a hardened strip manufactured of abrasion resistant steel armor plate such as AR400, AR500 or other such steel alloy. That is, the roll-off rails 1204 may be manufactured of the same or a different material than that of the container 1200 to facilitate sliding along the vehicle to which the slurry box 101A may roll-on/roll-off (FIG. 3).

The latch attachment assembly 1604 (two shown) are mounted to the reinforcement 1602 such as via bolts 1603 (FIG. 17B). The latch attachment assembly 1604 includes a striker bolt 1616 generally parallel to the reinforcement 1602 to which the hydraulic lock assembly 1610 engage. In embodiments, maintaining hydraulic pressure assures the respective hydraulic lock assembly 1610 remain engaged with the respective latch attachment assembly 1604 to maintain the tailgate 110A in a closed and locked position.

With reference to FIG. 17B, the hydraulic lock assembly 1610 generally includes the lateral support members 1612A, 1612B which each support a respective hydraulic cylinder 1620 that drive respective lock pins 1622 along an axis L transverse to the hinge axis H so as to engage the respective striker bolt 1616. In embodiments, the hydraulic cylinder 1620 may be power-in, power-out rams which are known as a double-acting hydraulic cylinder that uses hydraulic fluid pressure to both extend (push) and retract (pull) the piston rod.

The lock pins 1622 may include a chamfered distal end 1615 to engage between the respective striker bolt 1616 and a plate 1617 of the latch attachment assembly 1604. That is, the chamfered distal end 1615 forms a ramped surface to wedge the tailgate closed. In embodiments, the chamfered distal end 1615 may be formed to have three (3) surfaces including a slope portion 1615A, a flat portion 1615B, and a round portion 1615C. When the lock pins 1622 are inserted, the horizontal striker bolt 1616 rests against the flat portion 1615B, therefore only horizontal pressure is applied, not vertical pressure to facilitate operation of the respective hydraulic cylinder 1620.

The hydraulic cylinders 1620 may be pivotally mounted and at least partially contained within the lateral support members 1612A, 1612B. The hydraulic cylinders 1620 may be pivotally attached to the respective lateral support members 1612A, 1612B along an axis S which may be parallel to the hinge axis H by a pin 1624 and bushing 1626 arrangement. The pin 1624 and bushing 1626 arrangement provides a relatively close tolerance not otherwise directly available with respect to the square tube lateral support members 1612A, 1612B.

The lock pins 1622 may be attached to the respective hydraulic cylinders 1620 via a pin 1628 that may be retained therein by a safety clip 1630. The lock pins 1622 may be at least partially supported within a respective sleeve 1632 that may be mounted within the tailgate bottom support member 1606. The sleeve 1632 may be manufactured of a different material than the tailgate bottom support member 1606 to, for example, provide a close tolerance, reduce friction, and/or simplify manufacture of the tailgate bottom support member 1606. The sleeve 1632 provides a relatively close tolerance and sliding support for the lock pins 1622.

Once the tailgate 110A is moved to the closed position by the hydraulic actuation system 900 such that the tailgate 110A fluidly seals the opening, the tailgate 110A is secured by the hydraulic lock assembly 1520, the lock pins 1622 arranged transverse to the hinge axis H that assures an effective seal and compresses the seal 1210 to fill any voids between the vacuum tank 102 and tailgate 110A. Once the respective hydraulic cylinders 1620 are extended under hydraulic pressure, addition fluid pressure is not required as the hydraulic pressure then remains, static, although pressure may still remain in lines.

The hydraulically lockable tailgate end assembly 1500 facilitates operation which may include a remote control system such that minimal operator effort is required during dumping of the slurry. That is, a wireless and/or wired remote may be utilized to operate the hydraulic actuation system 900. The remote also allows the operator to stand clear of dumping operations.

Although the different non-limiting embodiments have specific illustrated components, the embodiments of this invention are not limited to those particular combinations. It may be possible to use some of the components or features from any of the non-limiting embodiments in combination with features or components from any of the other non-limiting embodiments.

The foregoing description may be example rather than defined by the limitations within. Various non-limiting embodiments are disclosed herein, however, one of ordinary skill in the art would recognize that various modifications and variations in light of the above teachings will fall within the scope of the appended claims. It may be therefore to be appreciated that within the scope of the appended claims, the disclosure may be practiced other than as specifically described. For that reason the appended claims should be studied to determine true scope and content.

While various inventive aspects, concepts and features of the general inventive concepts are described and illustrated herein in the context of various example embodiments, these various aspects, concepts and features may be used in many alternative embodiments, either individually or in various combinations and sub-combinations thereof.

Unless expressly excluded herein all such combinations and sub-combinations are intended to be within the scope of the general inventive concepts. Still further, while various alternative embodiments as to the various aspects, concepts and features of the inventions (such as alternative materials, structures, configurations, methods, devices and components, alternatives as to form, fit and function, and so on) may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the general inventive concepts even if such embodiments are not expressly disclosed herein. Additionally, even though some features, concepts or aspects of the inventions may be described herein as being a preferred arrangement or method, such description may be not intended to suggest that such feature may be required or necessary unless expressly so stated. Still further, example or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification may be not intended to be exclusive, but rather there may be inventive aspects, concepts and features that are fully described herein without being expressly identified as such or as part of a specific invention. Descriptions of example methods or processes are not limited to inclusion of all steps as being required in all cases, nor may be the order that the steps are presented to be construed as required or necessary unless expressly so stated.

What may be claimed is:

1. A tailgate assembly for a roll-off container, comprising:
a tailgate;
a hinge assembly mounted the tailgate, such that the tailgate is movable between an open position and a closed position about a hinge axis parallel to a top of the tailgate;
a hydraulic actuation system operable to move the tailgate between the open position and the closed position; and
a hydraulic lock assembly to maintain the tailgate in the closed position.

2. The tailgate assembly as recited in claim 1, wherein the tailgate comprises a top, a bottom, a first side, and a second side, the top comprises a tailgate top support member, the bottom comprises a tailgate bottom support member, the first side comprises a tailgate first side support member, and the second side comprises a tailgate second side support member, each support member comprises a steel tube that is square in cross-section.

3. The tailgate assembly as recited in claim 2, further comprising a first lateral support member and a second lateral support member that extends between the bottom support member and the top support member.

4. The tailgate assembly as recited in claim 3, wherein the hinge assembly comprises:
a first hinge support member attached to the tailgate first side support member;
a second hinge support member attached to the first lateral support member;
a third hinge support member attached to the second lateral support member; and
a fourth hinge support member attached to the tailgate second side support member.

5. The tailgate assembly as recited in claim 4, further comprising:
a first longitudinal support member that extends between the first side support member and the first lateral support member; and
a second longitudinal support member that extends between the second side support member and the second lateral support member.

6. The tailgate assembly as recited in claim 5, further comprising:
a third lateral support member that extends between the first lateral support member and the bottom support member; and
a fourth lateral support member that extends between the second lateral support member and the bottom support member.

7. The tailgate assembly as recited in claim 6, wherein the hydraulic actuation system comprises:
a first hydraulic cylinder pivotally attached to the first longitudinal support member, and
a second hydraulic cylinder pivotally attached to the second longitudinal support member.

8. The tailgate assembly as recited in claim 7, wherein the hydraulic lock assembly comprises the first lateral support member and the second lateral support member.

9. The tailgate assembly as recited in claim 8, further comprising a first latch attachment assembly and a second latch attachment assembly mounted to a reinforcement mounted to the roll-off container.

10. The tailgate assembly as recited in claim 9, wherein the reinforcement is mounted between a first and second roll-off rail of the roll-off container.

11. The tailgate assembly as recited in claim 10, wherein the first latch attachment assembly is mounted transverse to the first lateral support member, and the second latch attachment assembly is mounted transverse to the second lateral support member.

12. The tailgate assembly as recited in claim 11, wherein the first and second hydraulic cylinders are pivotally attached to the respective lateral support members along an axis which is parallel to the hinge axis by a pin and bushing arrangement.

13. The tailgate assembly as recited in claim 12, further comprising a lock pin attached to the first and second hydraulic cylinders via a pin that is retained therein by a safety clip, wherein the lock pin comprises a chamfered distal end, the chamfered distal end comprises three (3) surfaces including a slope portion, a flat portion, and a round portion.

14. The tailgate assembly as recited in claim 13, wherein the lock pin of the first and second hydraulic cylinders are engageable with the respective first and second latch attachment assembly.

15. The tailgate assembly as recited in claim 14, wherein the lock pin of the first and second hydraulic cylinders are engageable with the respective first and second latch attachment assembly.

16. The tailgate assembly as recited in claim 14, wherein the first and second latch attachment assembly each comprise a striker bolt generally parallel to the reinforcement to which the lock pin of the first and second hydraulic cylinders engage.

17. The tailgate assembly as recited in claim 1, wherein the tailgate is rectilinear.

18. The tailgate assembly as recited in claim 14, wherein the tailgate opens to about 100 degrees with respect to the closed position.

19. The tailgate assembly as recited in claim 18, further comprising a seal located between the container and the tailgate when the tailgate is in the closed position an opening in the tailgate within the perimeter defined by the seal.
